(19) United States
(12) Patent Application Publication
(10) Pub. No.: US 2009/0129065 A1
(43) Pub. Date: May 21, 2009

(54) PEN WITH MAGNIFIER

(76) Inventors: Giora Tamir, Chestnut Ridge, NY (US); Tali Tamir, Chestnut Ridge, NY (US); Shlomo Berkovitz, Herzelia (IL)

Correspondence Address: YORAM TSIVION, P.O. BOX 1307, PARDES HANNA, 37111, IL

(21) Appl. No.: 11/940,582

(22) Filed: Nov. 15, 2007

(51) Int. Cl. B43K 29/10

(52) U.S. Cl. 362/118; 401/195

(57) ABSTRACT

A pen is provided with optical magnifying capabilities, and, optionally, further includes an illuminating device. The pen functions as a writing tool so that a user can easily hold it to write. A double prismatic lens is disposed inside a lower casing of the pen and by manipulating a selector switch, a user can control the magnifying level. An LED is disposed inside casing of the pen and a light producing assembly (LPA) is disposed in a lower pen sleeve. Correspondingly, by pushing the selector switch, the LPA is electrically connected to the battery and to a switch to turn on or off an LED.

### FIELD OF THE INVENTION

The present invention is in the field of personal stationery items. More specifically the invention relates to a pen capable of magnifying and illuminating.

### BACKGROUND OF THE INVENTION

A pen is a writing instrument that applies ink to a surface, usually paper. Generally, the pen is an elongated body having first and second ends, with a ball point or other writing tip associated with the first end. The writing tip, prevalently, contains a replaceable ink reservoir transferring ink to the receiving paper, while writing is carried out. In the case of a ball pen, as the pen moves across a paper, the ball turns and gravity forces the ink down the reservoir and onto the ball where it is transferred onto the paper. Externally, the pen is a grippable casing, structured to facilitate comfortable and firm grip, to enable the user to maintain a suitable posture as he or she write along. Within such casing, a space is further provided for additional elements to be disposed therein.

### BRIEF DESCRIPTION OF THE DRAWINGS

FIG. 1 is an isometric description of optically magnifying pen (OMP) in accordance with the preferred embodiment of the present invention.

FIG. 1A and FIG. 1B are isometric side view, of optically magnifying pen (OMP) in accordance with the preferred embodiment of the present invention;

FIG. 2 is an exploded schematic view of OMP in accordance with a preferred embodiment of the present invention;

FIG. 3 is an enlarged isometric view of illuminating assembly (IA) of the pen in accordance with a preferred embodiment of the present invention;

### SUMMARY OF THE INVENTION

In accordance with the present invention, a pen is provided with optical magnifying capabilities, and, optionally, further includes an illuminating device. The latter is inserted inside the casing forming the body of the pen. By depressing a selector switch disposed at one end of the pen, the user can induce light emission by activating a LED installed within, whereas by manipulating a selector switch, the user can control the magnifying level of double-prismatic lenses.

### DETAILED DESCRIPTION OF THE PRESENT INVENTION

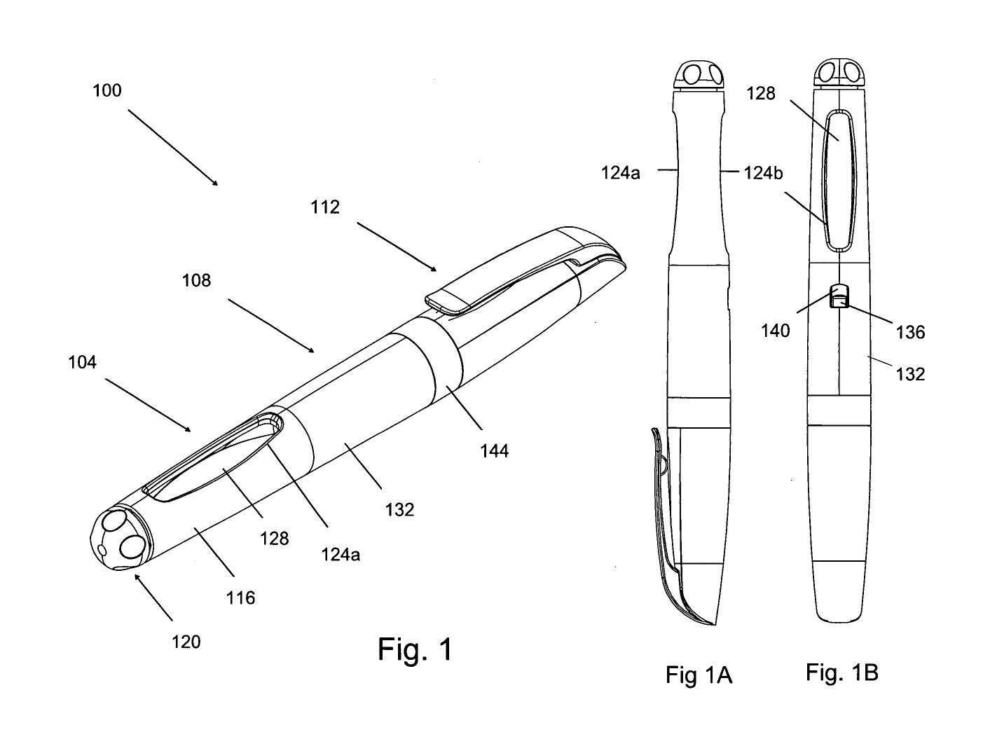

An optical magnifying pen (OMP) in accordance with a preferred embodiment of the present invention is described in FIG. 1 to which reference is now made. OMP 100 includes three modules as follows: optical magnifying assembly (OMA) 104, illuminating assembly (IA) 108 and writing assembly (WA) 112 at the front of the OMP. OMA 104 includes a hollow cylindrical barrel 116 having both open ends threaded (not shown here), and selector switch 120. Hollow cylindrical barrel 116 is furnished with two transparent windows 124a (only one shown). In FIG. 1A, an isometric side view, to which reference is now made, the position of the aforementioned windows can be seen more clearly. The windows are mutually opposing for viewing through a portion of double prismatic lens (DPL) 128 disposed inside OMA 104. Referring again to FIG. 1, IA 108 includes a hollow cylindrical barrel 132 having two threaded open ends. Reference is now made to FIG. 1B in which barrel 132 is shown further to include a light emitting diode (LED) 136 which is disposed within aperture 140. Aperture 140 is shaped such that when the LED is activated, the illumination is directed towards the OMA. WA 112 and IA 108 are interconnected by ring 144, concealing one threaded end of WA (not shown).

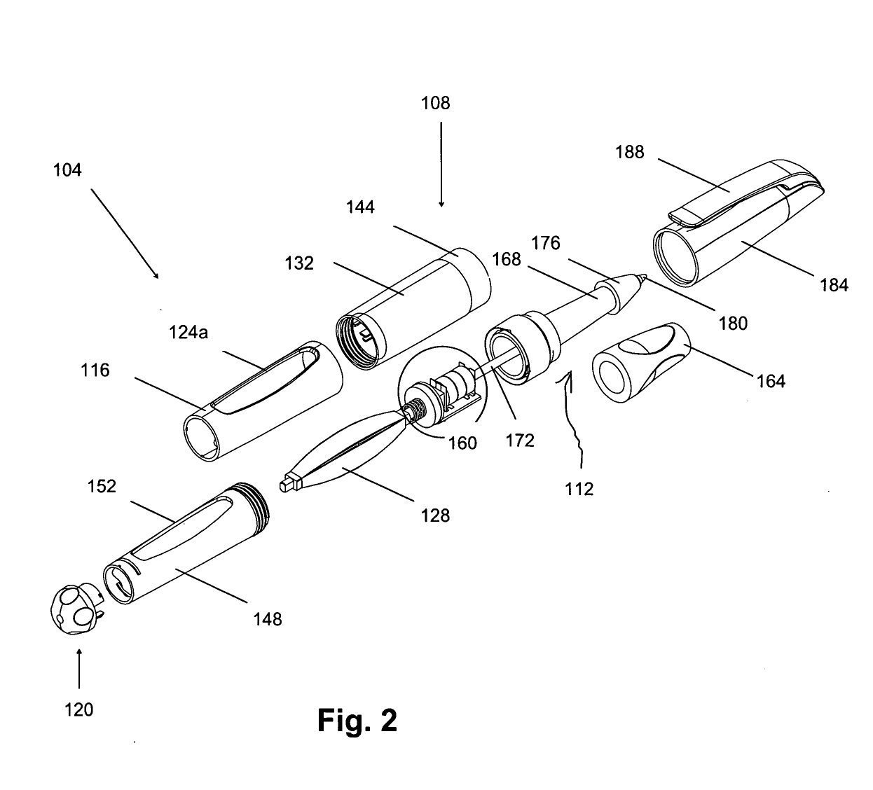

An exploded view of the OMP in accordance with a preferred embodiment of the present invention is shown in FIG. 2 to which reference is now made. OMA consists of outer and inner hollow cylindrical barrels 116 and 148 respectively, double prismatic lens (DPL) 128 and selector switch 120. Barrel 116 confines hollow barrel 148 internally and is coaxial with it. Within the barrels, double prismatic lens (DPL) 128 allowing for two magnification levels is disposed. Hollow barrels 116 and 148 are each furnished with respective transparent windows 124a and 152. By turning selector switch 120, one of a selected lens of DPL 128 becomes viewable trough windows 124a and 152. Cylindrical barrel 132 covers light producing assembly (LPA) 160 of the illuminating assembly. A detailed description of the components of the IA will be given below. Writing Assembly 108 consists of a frusto-conical gripping cover 164, inner barrel 168, ink cartridge 172 and funnel shaped adapter 176. Inner barrel 168 is a cylindrical hollow tube tapering in one end, covered by gripping cover 164. Adapter 176 is disposed in front of cover 164. The other end of barrel 168 is threaded for connecting to cylindrical barrel 132 front sleeve. Gripping cover 164 is furnished with elastic gripping region, typically, made of rubber. Ink cartridge 172 has a hollow bore referred to hereinafter as channel that extended longitudinally through WA 112 components. Tip 180 of the ink cartridge is the disposed at the very front of the OMP, protruding from the OMP functioning as the outlet for ink. All inner components of WA 112 are disposed within detachable cap 184, thereby having one open end threaded, whereas its second end includes clip 188.

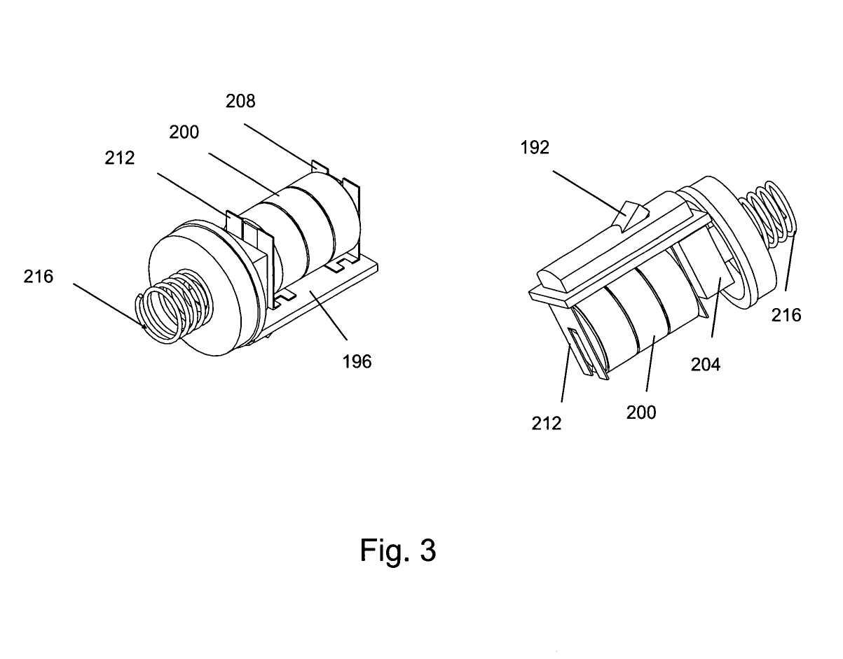

The IA, generally, includes a LED. In FIG. 3, to which reference is now made, an enlarged isometric view of the IA of the invention is shown. LED (not shown), LED housing 192, printed circuit board (PCB) 196, battery pack 200 and LED actuation button (LAB) 204. The batteries pack is temporary affixed to PCB 196 and disposed between plates 208 and 212. LAB 204 is disposed adjacent to Plate 212. The LAB is typically actuated mechanically. In some embodiments, the proximal end of the DPL is in physical contact with the LAB and by applying a force onto the distal end of the DPL, for example by pushing selector switch 120, spring 216 is compressed, whereby LAB is pressed and consequently actuated (not shown). The depressing of LAB thereby closes an electrical circle to induce light emission by a LED. In some embodiments, the LED light can be turned off upon successive depressing of the LAB. In addition, a provision can be provided for the LED light to be automatically turned off after predetermined period. Such is typically implemented electronically.

The magnifying assembly although described above as including a double prismatic lens, is not necessarily restricted in the number magnifications available. Thus three, four or higher viewing options involving various respective magnification may be provided,

It is to be understood that the ongoing description and associated drawings are made for purposes of illustration only, and are not intended as a definition of the limits and scope of the invention disclosed.

### BENEFITS OF A PEN OF THE INVENTION

From a review of the foregoing description of the preferred embodiments of the present invention, a number of advantages will become apparent to those of skill in the art. The device disclosed, insures stable and comfortable gripping, so that a user will be able to write for a long period of time without causing distress in finger joints. The combined functionalities of the components of the pen of the invention, provide a useful and convenient personal tool. In operation, while, the pen's light-emitting diode (LED) can shed light onto a specific textual or descriptive graphic data on a page to be read, the elderly/short-sightedness user, as a complementary act, can also use the magnifier to enlarge the data.

1. A pen comprising:
a writing assembly, and
a magnifying assembly having at least two magnification levels.

2. The pen as in claim 1, further comprising an illuminating element.

3. The pen as in claim 1, whereas said magnifying assembly includes a double-prismatic lens.

4. The pen as in claim 1, whereas said illuminating assembly is a light emitting diode (LED).

5. The pen as in claim 1, whereas said illuminating element and said magnifying are actuated by switching a selector switch.
